(19) United States
(12) Patent Application Publication
(10) Pub. No.: US 2014/0067520 A1
(43) Pub. Date: Mar. 6, 2014

(54) Methods, Systems and Apparatuses for Analyzing and Comparing Performance of Marketing Channels in Integrated Marketing Campaigns

(71) Applicant: Ryan Campanile, Baton Rouge, LA (US)

(72) Inventor: Ryan Campanile, Baton Rouge, LA (US)

(73) Assignee: SMARTBRIDGE, LLC, Houston, TX (US)

(21) Appl. No.: 13/597,226

(22) Filed: Aug. 28, 2012

(51) Int. Cl. G06Q 30/02

(52) U.S. Cl. 705/14.42

(57) ABSTRACT

Methods, systems and apparatuses are disclosed for collecting, over a time period in near real time, non-broadcast marketing performance data regarding marketing communications of an offering through two or more providers over the time period on a per provider basis. The non-broadcast marketing performance data for each provider is stored in a separate staging database in provider-specific formats. The non-broadcast marketing performance data is converted from the provider-specific formats to specialized format and stored in a dimensional database. Web site usage data, including at least one web usage metric, about the impact of the advertising on a web site relating to the offering is collected over the time period in near real time. The near real time non-broadcast marketing performance data is correlated with the near real time web site usage data. The correlation includes a graphical comparison of the impacts of the marketing communications in a web usage metric.

### RELATED APPLICATIONS

This application relates to the following commonly assigned co-pending applications entitled:

“Methods, Systems and Apparatuses for Analyzing the Effectiveness of Broadcast Advertising in and on Integrated Marketing Campaigns,” Ser. No. _____, filed Aug. 28, 2012, and “Methods, Systems and Apparatuses for Analyzing and Comparing Return on Investment Performance of Marketing Channels in Integrated Marketing Campaigns,” Ser. No. _____, filed Aug. 28, 2012, all of which are incorporated in their entireties by reference herein.

### TECHNICAL FIELD OF THE INVENTION

The present disclosure relates generally to systems, methods, and apparatuses for analyzing marketing. More particularly, the disclosure relates to systems, methods and apparatuses for analyzing the effectiveness of media advertising in near real time and comparing the effectiveness of different marketing channels.

### BACKGROUND

Firms, small businesses, and individuals offering goods or services—and even non-profits—often spend considerable amounts of money for advertisement. In an article entitled “U.S. advertising spending totaled $144 billion in 2011,” dated Mar. 13, 2012, the LA Times reported that, according to data from Kantar Media, advertising expenditures in the United States totaled $144 billion (USD) in 2011. Some of the media channels include television, radio, print, and on-line/digital methods. Examples of on-line/digital methods include on-line advertisements, social media, and e-mail advertising.

In order to determine whether their advertising dollars are being well spent, advertisers need to be able to compare results from different advertising campaigns and compare results when the advertising is performed through different channels. Advertisers need to be able to respond quickly if a particular advertising campaign has a strong effect on their existing and potential customers. They also may desire to focus their expenditures through the channels that are most effective at reaching their target audience. In order to do so, however, the advertisers must quickly obtain and analyze data reflecting their audience response to the advertising. It is important to respond quickly if a particular advertisement or advertising campaign has a positive effect on the target audience, but it may be even more imperative to take immediate steps if such an advertisement or campaign proves to be distasteful or otherwise unattractive to even a small segment of their target audience.

It can be difficult to obtain and analyze such data quickly, however. Although digital marketing does lend itself to attribution better than the more traditional methods of advertising, there are still issues that arise relying solely on current methods. If a potential customer pulls up a company web site, for example, it can be difficult to determine exactly what led the potential customer to that web site.

Accordingly, a need is present for methods, systems, and apparatuses to address and/or overcome issues discussed above.

### SUMMARY

The embodiments of the invention described herein include a method of collecting, over a time period in near real time, non-broadcast marketing performance data regarding marketing communications of an offering through at least two providers. The at least two providers are from at least one non-broadcast marketing venue in at least one non-broadcast marketing channel. The non-broadcast marketing performance data is collected on a per provider basis in provider-specific formats. The method includes storing the near real time, non-broadcast marketing performance data for each provider in a staging database in a provider-specific format, transforming the near real time, non-broadcast marketing performance data of each provider from the provider-specific formats to a specialized format, and storing the near real time, non-broadcast marketing performance data in a dimensional database in the specialized format. The method also includes collecting, over the time period in near real time, web site usage data, including at least one web usage metric, about an impact of the marketing communications on a web site relating to the offering. The method also includes correlating the near real time, non-broadcast marketing performance data in the specialized format with the near real time web site usage data to create at least one evaluation of the impacts of the marketing communications, on at least an overall marketing level of granularity, on at least one web usage metric and creating a marketing performance report including the evaluation.

The embodiments of the invention described herein include an apparatus with a marketing performance data interface configured to collect, over a time period in near real time, non-broadcast marketing performance data regarding marketing communications for an offering through at least two providers. The at least two providers are from at least one marketing venue in at least one non-broadcast marketing channel. The non-broadcast marketing performance data is collected on a per provider basis. The apparatus also includes a staging area within the marketing performance data interface having a staging database for each provider configured to store the non-broadcast marketing performance data from the provider in a provider-specific format. The marketing performance data interface is further configured to transform the non-broadcast marketing performance data from the provider-specific formats to a specialized format. The apparatus also includes a dimensional database coupled to the marketing performance data interface, the dimensional database being configured to store the non-broadcast marketing performance data in the specialized format. The apparatus also includes a web analytics system configured to obtain web site usage data from a provider in the at least one non-broadcast marketing channel and from a web site for the offering, the web site usage data including at least one web usage metric, about the impacts of the marketing communications relating to the offering. The apparatus also includes a marketing performance measurement reporting system configured to pull the non-broadcast marketing performance data from the dimensional database, to pull the web site usage data from the web analytics system, to correlate the pulled non-broadcast marketing performance data with the pulled web usage data to create at least one evaluation of the impacts on the basis of at least one web usage metric, at least an overall marketing level of granularity, and to prepare a report including the evaluation.

The embodiments of the invention described herein include an article of manufacture comprising a medium storing instructions that, if executed, enable a processor-based system to collect, over a time period in near real time, non-broadcast marketing performance data regarding advertisements of an offering through two or more providers over the time period (the non-broadcast marketing performance data being collected on a per provider basis), store the near real time, non-broadcast marketing performance data for each provider in a separate staging database in provider-specific formats, transform the near real time, non-broadcast marketing performance data from the provider specific formats to a specialized format and store the re-formatted near real time, non-broadcast marketing performance data in a dimensional database, collect, in near real time, web site usage data about the impact of the advertising on a web site relating to the offering (wherein the web site usage data is collected on a provider basis), correlate the near real time marketing performance data with the near real time web site usage data (wherein the correlation includes a graphical comparison of the impacts of the at least two providers in a web usage metric), and display the correlation.

The embodiments of the invention described herein include a system which includes at least two provider computer systems of at least two providers configured to assemble non-broadcast marketing performance data regarding marketing communications for an offering, the non-broadcast marketing performance data being assembled in a provider-specific format and a marketing performance data interface coupled to the at least two provider computer systems. The marketing performance data interface is configured to collect, over a time period in near real time, the non-broadcast marketing performance data from the at least two provider computer systems, the non-broadcast marketing performance data collected on a per provider basis. The system also includes a staging area within the marketing performance data interface, the staging area having a staging database for each provider configured to store the non-broadcast marketing performance data from the provider in its provider-specific format. The marketing performance data interface is further configured to transform the non-broadcast marketing performance data from the provider-specific formats to a specialized format. The system also includes a dimensional database coupled to the marketing performance data interface, the dimensional database configured to store the non-broadcast marketing performance data in the specialized format. The system also includes a web site for the offering accessible to potential customers an a web analytics system configured to obtain web site usage data from a provider in the at least one non-broadcast marketing channel and from the web site for the offering. The web site usage data includes at least one web usage metric, about the impact of marketing communications, on at least an overall marketing campaign level of granularity, on the web site relating to the offering. The system also includes a marketing performance measurement reporting system configured to pull the non-broadcast marketing performance data from the dimensional database, to pull the web site usage data from the web analytics system, to correlate the pulled non-broadcast marketing performance data with the pulled web usage data to create at least one evaluation of the impacts on the basis of at least one web usage metric, at least an overall marketing level of granularity, and to prepare a report including the evaluation. The at least two providers are from at least one marketing venue in at least one non-broadcast marketing channel.

Other aspects and advantages of the embodiments described herein will become apparent from the following description and the accompanying drawings, illustrating the principles of the embodiments by way of example only.

### BRIEF DESCRIPTION OF THE DRAWINGS

Features and advantages of the present invention will become apparent from the appended claims, the following detailed description of one or more example embodiments, and the corresponding figures.

FIG. 1 is a block diagram depicting a system for analyzing and comparing the performance of marketing channels, in accordance with one or more embodiments of the present disclosure;

FIG. 2 is a flowchart depicting a process for analyzing and comparing the performance of marketing channels, in accordance with one or more embodiments of the present disclosure;

FIG. 3 is a diagram illustrating a comparison of marketing channel performances, in accordance with one or more embodiments of the present disclosure;

FIG. 4 is a screenshot of a campaign summary display highlighting results of various marketing channels and including a comparative representation, in accordance with one or more embodiments of the present disclosure;

FIG. 5 is a screenshot of a campaign summary display depicting details of results of various marketing channels, in accordance with one or more embodiments of the present disclosure;

FIG. 6 is a screenshot of a campaign summary display depicting details of marketing channel impact on a web site, in accordance with one or more embodiments of the present disclosure;

FIG. 7 is a screenshot of a summary display depicting details of marketing channel results impacting various pages of a web site, in accordance with one or more embodiments of the present disclosure;

FIG. 8 is a block diagram depicting a system for analyzing and comparing marketing channels (in this example, the performance of two marketing channels and three providers), in accordance with one or more embodiments of the present disclosure;

FIG. 9 is a flowchart depicting a process for analyzing and comparing the performance of marketing channels (in this example, the performance of three marketing channels), in accordance with one or more embodiments of the present disclosure; and

FIG. 10 depicts an architecture, in accordance with one or more embodiments of the present disclosure, to implement the marketing channel analysis system.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### NOTATION AND NOMENCLATURE

Certain terms are used throughout the following description and claims to refer to particular system components and configurations. As one skilled in the art will appreciate, companies may refer to a component by different names. This document does not intend to distinguish between components that differ in name but have similar functions. In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection, or through an indirect connection via other devices and connections.

“The internet” is a network of networks and gateways that use the TCP/IP suite of protocols. “A client” is a computer accessed by a user or viewer which issues commands to another computer called “a server.” The server performs a task associated with the client's command. “The World Wide Web” (WWW or Web) is the internet's application which displays information on the internet in a user-friendly graphical user interface format called a Web page. “A Web server” typically supports one or more clients. The Web allows users (at a client computer) who seek information on the internet to switch from server to server and database to database by viewing objects (images or text) and clicking (with a pointing device or keystroke) on corresponding highlighted words or phrases of interest (hyperlinks).

The Web includes the internet with all of the resources addressed or identified as Universal Resource Locators (URLs), which displays the information corresponding to URLs and provides a point-and-click interface to other URLs. A URL can be thought of as a Web document version of an e-mail address. Part of a URL is termed the Internet Protocol (IP) address.

An internet browser or Web browser is a graphical interface tool that runs internet protocols and displays results on the user's screen. The browser can act as an internet tour guide, complete with pictorial desktops, directories, and search tools used when a user “surfs the net.”

The phrase “marketing channel,” as used herein, refers to different types of methods for advertising an offering, such as a product or service. Examples of marketing channels include e-mail marketing, on-line advertising, social media advertising, broadcast media advertising (which may include such venues such as television advertising, radio advertising, billboard advertising (both static and electronic), newspaper advertising, catalogs and mass mailings), and search engine optimization. An advertisement is “exposed” when a page which contains a slot with the advertisement is served to a client accessing the page. Since a page may typically contain more than one slot, more than one advertisement may be exposed at a single time. This exposure of an advertisement is also called “an impression.” An advertisement is clicked when a client decides to choose (with a pointing device or keystroke) the link corresponding to an exposed advertisement. Thus, the number of clicks for an advertisement is always a certain fraction of the number of exposures. Advertisement agencies often measure the effectiveness of an advertisement by the number of clicks that an advertisement receives.

The terms “advertising” and “advertisement(s)” are used herein to mean communications made to a target audience through paid announcements, which may be made through various marketing channels, promoting an offering. The term “marketing communication” includes advertising, but may also include other promotional aspects of marketing, such as public relations, media relations, publicity, design of packaging and of web sites for firm or an offering, design and use of marks, use of endorsements, client development and retention, and social media. While some embodiments are described with respect to advertising, other embodiments may include other types of marketing communications. The examples of various embodiments should be considered illustrative rather than limiting.

The term “conversion,” as used herein, is defined as a completion of a goal. Some examples of conversions include purchasing an offering, registering on a web site, signing up for a service, or downloading a white paper.

The phrase “near real time,” as used herein, means almost in real time as events happen, allowing for updating by the provider (which may be done in near real time or on a periodic basis, depending upon the provider) and transmission and processing of data, but without significant delay. Real time, if taken to mean absolutely simultaneously, may be unobtainable, as even light takes time to go from one point to another.

### DETAILED DESCRIPTION

In light of the principles and example embodiments described and illustrated herein, it will be recognized that the example embodiments can be modified in arrangement and detail without departing from such principles. Also, the foregoing discussion has focused on particular embodiments, but other configurations are contemplated. In particular, even though expressions such as “in one embodiment,” “in another embodiment,” or the like are used herein, these phrases are meant to generally reference embodiment possibilities, and are not intended to limit the invention to any particular embodiment configurations. As used herein, these terms may reference the same or different embodiments that are combinable into other embodiments.

Similarly, although example processes have been described with regard to particular operations performed in a particular sequence, numerous modifications could be applied to those processes to derive numerous alternative embodiments of the present invention. For example, alternative embodiments may include processes that use fewer than all of the disclosed operations, processes that use additional operations, and processes in which the individual operations disclosed herein are combined, subdivided, rearranged, or otherwise altered.

This disclosure also described various benefits and advantages that may be provided by various embodiments. One, some, all, or different benefits or advantages may be provided by different embodiments.

In view of the wide variety of useful permutations that may be readily derived from the example embodiments described herein, this detailed description is intended to be illustrative only, and should not be taken as limiting the scope of the invention. What is claimed as the invention, therefore, are all implementations that come within the scope of the following claims, and all equivalents to such implementations.

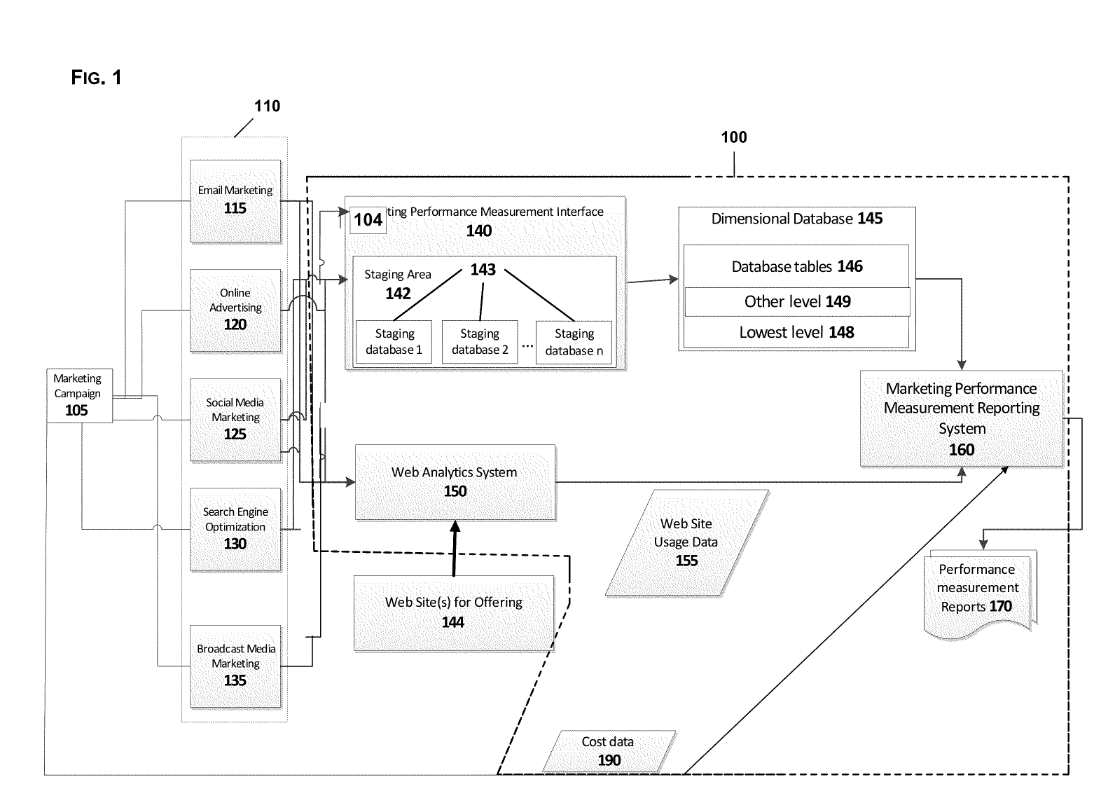

FIG. 1 is a block diagram depicting a marketing channel analysis system 100 for analyzing and comparing the performance of marketing channels, in accordance with one or more embodiments of the present disclosure. Referring to FIG. 1, a marketing campaign 105 is initiated by advertising an offering (such as a product or service) in one or more marketing channels 110 over a period of time. The marketing channels 110, illustrated in FIG. 1, include an e-mail marketing channel 115, an on-line advertising channel 120, social media marketing channel 125, a search engine optimization channel 130, and a broadcast media marketing channel 135. Each channel of advertising may include one or more providers which display the advertising during the period of time.

Advertising through the e-mail marketing channel 115 may include advertisements sent as e-mail messages to one or more e-mail addresses. The e-mail addresses may be, for example, from individuals who have registered with a particular goods and/or services provider, from individuals who are former customers (collected via cookies or other means), from other merchants selling e-mail lists, or from a supplier of e-mail addresses. Advertising through the on-line advertising channel 120 may be conducted by placing advertisements to be displayed on various web sites. Marketing through the social media marketing channel 125 may be conducted through one or more social media providers, such as Twitter®, Facebook®, LinkedIn®, or other such entities and may include one or more “conversations” conducted through the social media provider. (Display advertising which is placed on social media sites is generally considered “on-line” advertising.) Advertising through the search engine optimization channel 130 may include placing advertisements that appear on a web site when particular searches are performed, and may also include appending tags relating to search terms to one's web site to increase the chances that the web site will be found as a result of a particular search. Advertising though the broadcast media marketing channel 135 may include advertisements placed in television, newspapers, magazines and other broadcast media.

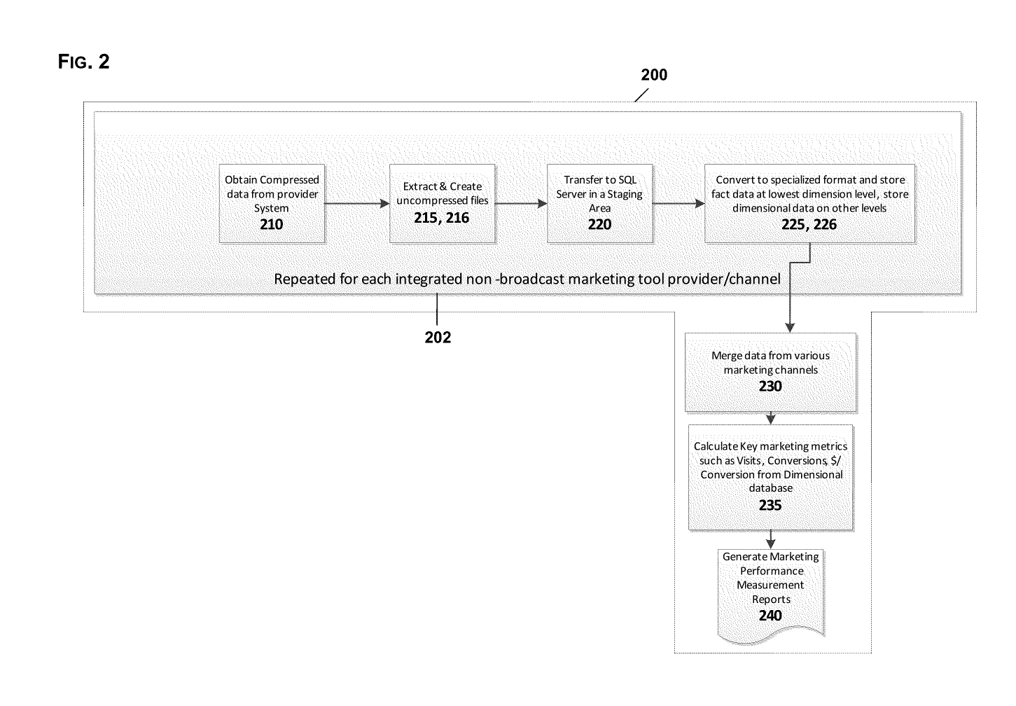

Referring again to FIG. 1, marketing performance data are collected from each non-broadcast provider in each marketing channel 110 in near real time by a marketing performance measurement interface 140. The marketing performance measurement interface 140 may use a provider-specific API to access and collect the marketing performance data from the providers in near real time. (The collection and analysis of marketing performance data is described in more detail in the discussion of FIG. 2 below.)

The marketing performance data for each channel generally includes information on the frequency and the scope of the advertising conducted through that channel. The marketing performance data may also include responses by potential customers if such data is collected by the provider. The marketing performance data may include a plurality of data specific to the channel. Thus, there might be e-mail marketing performance data, on-line marketing performance data, social media marketing performance data, search engine optimization marketing performance data, and/or broadcast media marketing performance data. The marketing performance data may even be specific to particular venues within the channel (such as television within the broadcast media channel) or to providers within the venues.

For example, the e-mail marketing performance data may include information such as the number of e-mails which were sent, the number of the e-mail messages which were opened by the recipient, the number of e-mails sent which bounced and were not delivered, or the number of times recipients clicked on a web link in the e-mail. The on-line marketing performance data may include the number of impressions, the number of clicks on the advertisement, a “click through rate,” the cost per click, and the cost per thousand of impressions. The broadcast media marketing performance data may include net reach, frequency of advertisements, and the cost of the advertisements. The print performance data may include impressions (that is, circulation) and the cost of the advertising.

The social media marketing channel performance information may be different for different social media venues and providers. For example, for conversations placed through Facebook®, the social media marketing channel performance information metrics may include the number of Facebook® fans, the number of wall posts, the number of interactions, the number of video views, and/or the number of photo views. For conversations placed through Twitter®, the social media marketing channel performance information metrics may include the number of Twitter® followers, the number of tweets, the number of re-tweets, and the number of mentions.

Referring again to FIG. 1, the marketing performance measurement interface 140 includes a staging area 142 having one or more staging databases 143. Preferably, there is one staging database 143 for each provider. As discussed in greater detail with respect to FIG. 2 herein, the marketing performance measurement interface 140 obtains the marketing performance data from each non-broadcast provider in near real time, processes the marketing non-broadcast marketing performance data, and stores it in the staging database 143 for the appropriate provider.

The broadcast marketing performance data is preferably collected and transformed as described more fully in co-pending U.S. patent application Ser. No. _____, entitled “Methods, Systems and Apparatuses for Analyzing the Effectiveness of Broadcast Advertising in and on Integrated Marketing Campaigns”, mentioned in the Related Applications section herein. The broadcast marketing performance data is uploaded to the marketing performance measurement interface 140 in a provider-specific format, preferably a spreadsheet format, such as Excel®. A market measurement interface 104 transforms the broadcast marketing performance data from the spreadsheet format to a specialized format of factual data and dimensional data. Examples of factual data include the actual number of clicks of the ads or the visits to a web site for the offering. Examples of dimensional data include the ads and the e-mails that have been sent out during the campaign.

The non-broadcast marketing performance data is also converted by the marketing performance measurement interface 140 from its provider-specific formats to the specialized format of factual data and dimensional data. The broadcast and non-broadcast marketing performance data in the specialized format of factual data and dimensional data is sent to a dimensional database 145, having one or more database tables 146. Each database table has a lowest level 148 and one or more other levels 149. The factual data is stored on the lowest levels 148 or the database tables 146, while the dimensional data is stored on other levels 149 in the database tables 146.

When a potential customer sees an ad/creative from one of the advertisement displays in a marketing channel and clicks a link to come to a web page for the offering, traffic data is tracked by a web analytics software 150. The web analytics software 150 may be any robust web analytics software such as Google® Analytics, Yahoo® Analytics, or any such analytic service. The web analytics software 150 is used to track, in near real time, all customer activity on the client's web site. The customer activity may have originated from any of the marketing channels 110. (There may even be customer activity un-related to the marketing channels 110.) The web analytics software 150 may use techniques, such as, for example, embedding tracking codes. A tracking code may be embedded in a url-link, which is placed on any creative such as an email advertisement, a banner advertisement, any posts on the social media, a blog advertisement, a magazine, catalog, or newspaper. The url may also be embedded in a QR code, which may be scanned by a potential customer. Using the url-link could bring the potential customer to a web site relating to an offering, which would have a corresponding tracking code. The tracking codes and corresponding tracking codes contain web usage data 155 about how the visitor arrived at the web site and what the visitor does at the web site. The web usage data may include one or more web usage metrics, with examples including the number of web site visits (“visits”), the number of pageviews, the number of unique pageviews, the average time on page, the number of bounces, the number of exits, the number of conversions, the number of registrations, and/or the cost per conversion. One or more of these web usage metrics may be considered a key metric. One or more of the web usage metrics (and or key metrics) may be associated directly with a marketing channel or with a specific venue or a provider. Other web usage metrics (and or key metrics) may not be directly associated with any specific marketing channel, venue or provider. Referring again to FIG. 1, the output of the web analytics software 150 is a web site usage data collection (“web usage data”) 155 that is sent to a marketing performance measurement reporting system 160.

When a user wants updated data, the marketing performance measurement reporting system 160 pulls the appropriate factual data and dimensional data from the database tables 146 in the dimensional database 145 as database objects and presents the data for viewing in HTML. The marketing performance measurement reporting system 160 also pulls the web usage data from the web analytics software 150, correlating the marketing performance data with the web usage data to create the performance measurement reports 170. The performance measurement reports 170 may include comparisons/correlations made on the basis of one or more web usage metrics and may include results at one or more layers of granularity.

FIG. 2 is a flowchart depicting a process 200 for collecting in near real time, storing and analyzing non-broadcast marketing performance data, as well as comparing the performance of different marketing channels to each other, in accordance with one or more embodiments of the present disclosure. For each marketing channel and/or provider, the marketing performance measurement interface 140 (not depicted in the flowchart of FIG. 2) obtains 210 a compressed data packet from a system of each provider displaying the advertisement or conversation. For the obtaining step 210, a background process within the marketing performance measurement interface 140 polls provider systems for new marketing performance data. The polling is preferably conducted continuously or at very short intervals. As the new marketing performance data becomes available in the form of the compressed data packet, the marketing performance measurement interface 140 extracts 215 the data from the compressed data packet and creates 216 uncompressed data packets for the data. The uncompressed data packets for each provider are transferred 220 to a corresponding staging database 143, such as a SQL server database, in the staging area 142 located in the marketing performance measurement interface 140. There is preferably one staging database for marketing performance data from each provider. The uncompressed data packets are then converted 225 from a provider-specific format to the specialized format of factual data and dimensional data and are sent to the dimensional database 145. Factual data is stored 226 at a lowest dimensional level 148 of the dimensional database 145. Dimensional data is stored at other levels 149 of the dimensional database 145. Marketing performance data from the various marketing channels are merged 230 so that comparisons may be made and so that the effectiveness of the marketing campaign as a whole may be assessed.

Web usage metrics, such as number of visits, number of conversions, and/or cost per conversion, are calculated 235 from web usage data in the dimensional database. One or more web usage metrics may be considered key metrics. A marketing performance measurement report is generated 240, which evaluates (compares and/or correlates) the performance of the two or more marketing channels, on the basis of one or more web usage metrics. The evaluations may include one or more levels of granularity, such as an analysis of the marketing performance on a provider basis or a venue basis.

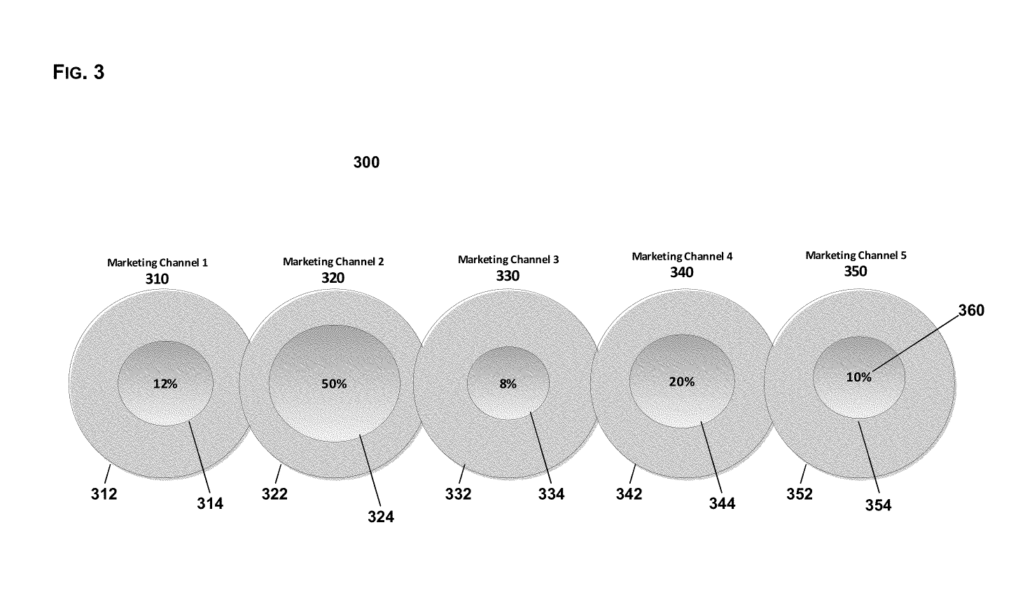

FIG. 3 is a diagram illustrating a comparison 300 of marketing channel performances, in accordance with one or more embodiments of the present disclosure. A key metric for a marketing campaign performance is selected. Once selected, contributions from each of two or more marketing channels 310, 320, 330, 340, 350 to the key metric are calculated. The percentage that each individual channel contributes to the key metric is depicted as a geometrical figure, such as inner circle 314, 324, 334, 344, 354. In the example of FIG. 3, the size of each inner circle 314, 324, 334, 344, 354 reflects the percentage that that particular marketing channel contributed to the key metric. Numerical values, such as numerical value 360, may be placed within the inner circle. The optional outer circles 312, 322, 332, 342, 352 are preferably uniform in size and may be used as place settings for additional information about the performance of the corresponding marketing channel 310, 320, 330, 340, 350.

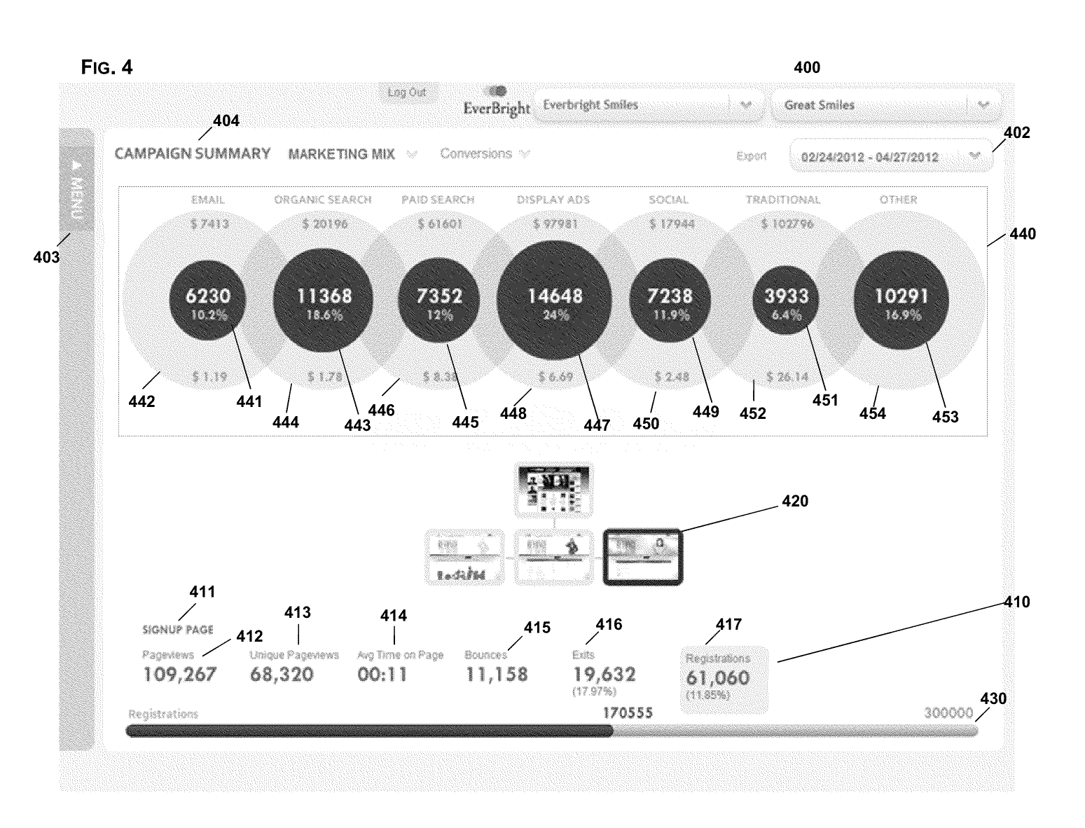

FIG. 4 is a screenshot of a campaign summary display 400, highlighting results of various marketing channels and includes a comparative representation, in accordance with one or more embodiments of the present disclosure. A date range 402 for data presented in the campaign summary display 400 is given near the upper right of the screenshot of FIG. 4. A flyout menu 403 appears at the left side of the screenshot of FIG. 4. A title 404, “Campaign Summary[:] Marketing Mix[,] Conversions” starts near the top left of the screenshot of FIG. 4. Several metrics relating to the signup page 411 are displayed near the bottom of the screenshot of FIG. 4, including number of pageviews 412, number of unique pageviews 413, average time on page 414, number of bounces 415, number of exits 416, and number of registrations 417. The number of unique pageviews 413 is the number of web site visits (for a web site related to the offering) during which a specified page(s) was/were visited at least once. A sliding scale 430 is depicted near the bottom of the screenshot of FIG. 4 and indicates the total goal of the marketing campaign for a key metric and how much of that goal has been met since the beginning of the marketing campaign. The sliding scale 430 indicates a campaign goal of 300,000 registrations, of which 170,555 have been achieved since the beginning of the marketing campaign. Thus, the sliding scale 430 may reflect a different time period than the date range 402. Over the date range 402 of Feb. 24, 2012 through Apr. 27, 2012, 61,060 registrations 417 have been achieved, a smaller number than the total number of registrations achieved since the beginning of the marketing campaign, as indicated by the sliding scale 430. In FIG. 4, the number of registrations 417 has been selected as the key metric. Continuing to refer to FIG. 4, the comparative representation 440 of the performance of different marketing channels is placed above the center of the screenshot of FIG. 4. In the example depicted in FIG. 4, results of seven marketing channels with respect to the key metric of registrations are depicted as inner circles 441, 443, 445, 447, 449, 451, 453 within outer circles 442, 444, 446, 448, 450, 452, 454.

In the example illustrated in FIG. 4, the inner circle 441 depicts that e-mail marketing resulted in 6,230 registrations (the large number within the inner circle 441), which was 10.2% (the small number in the inner circle 441) of the total number of registrations. The cost of the e-mail marketing was $7,413, which is the number positioned at the top of the outer circle 442, while the cost per conversion was $1.19, which is the number positioned at the bottom of the outer circle 442. Similarly, the inner circle 443 depicts that organic search marketing resulted in 11,368 registrations, which was 18.6% of the total number of registrations. The outer circle 444 indicates that the cost of the organic search marketing was $20,196, while the cost per conversion was $1.78. The inner circle 445 depicts that paid search marketing resulted in 7,352 registrations, which was 12% of the total number of registrations. The outer circle 446 indicates that the cost of the paid search marketing was $61,601, while the cost per conversion was $8.38. The inner circle 447 depicts that marketing from on-line display ads resulted in 14,648 registrations, which was 24% of the total number of registrations. The outer circle 448 indicates that the cost of the display ads was $97,981, while the cost per conversion was $6.69. The inner circle 449 depicts that social media marketing resulted in 7,238 registrations, which was 11.9% of the total number of registrations. The outer circle 450 indicates that the cost of the social media marketing was $17,944, while the cost per conversion was $2.48.

Continuing to refer to FIG. 4, the inner circle 451 depicts that marketing in traditional (broadcast) channels resulted in 3,933 registrations, which was 6.4% of the total number of registrations. The outer circle 452 indicates that the cost of the traditional (broadcast) marketing was $102,796, while the cost per conversion was $26.14. One should note that the conversions from traditional (broadcast) marketing may be under-represented as it is difficult to measure marketing impact directly from traditional (broadcast) sources. One cannot click on a radio advertisement, for example, so if a customer buys a product or seeks out a webpage as a result of a radio advertisement, it may be difficult to ascertain that the radio advertisement prompted the purchase or the inquiry. Techniques to measure impact of broadcast marketing may include listing special web sites or telephone numbers in the advertising, asking listeners to mention or enter a code word (or a program name or celebrity name), or to provide a code for scanning.

Referring again to FIG. 4, the inner circle 453 depicts that other marketing resulted in 10,291 registrations, which was 16.9% of the total number of registrations. The outer circle 454 for the “Other” category of channel does not indicate the cost of the other marketing or the cost per conversion. All direct visits to the web site also come under the “other” category. Another contributing factor to this category may be inaccurate attribution. The source of the registrations listed for the “other” marketing channel is usually from direct traffic and sometimes from duplicate attribution by multiple channels based on the tracking mechanism.

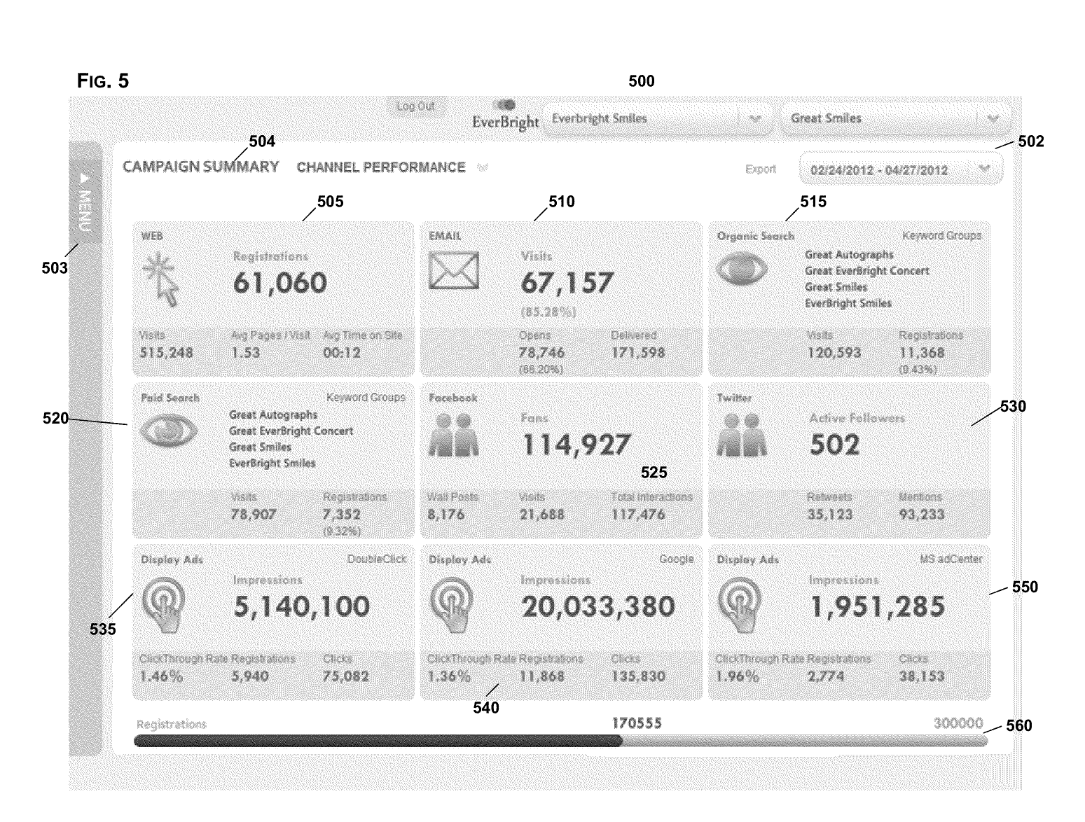

FIG. 5 is a screenshot of a campaign summary display 500, depicting details of results of various marketing channels, in accordance with one or more embodiments of the present disclosure. A date range 502 for the data is given near the upper right of the screenshot of FIG. 5. A flyout menu 503 appears at the left side of the screenshot of FIG. 5. A title 504, “Campaign Summary[:] Channel Performance” starts near the top left of the screenshot of FIG. 5. A sliding scale 560 is depicted near the bottom of the screenshot of FIG. 5 and indicates a campaign goal of 300,000 registrations, of which 170,555 have been achieved since the beginning of the marketing campaign. Nine boxes (a first box through a ninth box) 505, 510, 515, 520, 525, 530, 535, 540, 550 are depicted. The first box 505 indicates total results, over the date range 502, for the web site from the overall marketing effort, indicating 61,060 registrations, 515,248 visits to the web site, with 1.53 average pages per visit and an average time of site of 12minutes.

Continuing to refer to FIG. 5, boxes 505, 510, 515, 520, 525, 530, 535, 540, 550 provide information about performance of each marketing channel or provider depicted. The second box 510 indicates that e-mail marketing resulted in 67,157 web site visits, for a response rate of 85.28%. A total of 78,746 e-mail messages were opened of the 171,598 delivered, a rate of 66.20%. The third box 515 indicates that organic search marketing efforts using Great Autographs, Great EverBright Concerts, Great Smiles, and EverBright Smiles resulted in 120,593 web site visits, 11,368 registrations, and a conversion rate of 9.43%. The fourth box 520 indicates that paid search marketing efforts using Great Autographs, Great EverBright Concerts, Great Smiles, and EverBright Smiles resulted in 78,907 web site visits, 7,352 registrations, and a conversion rate of 9.32%. The fifth box 525 indicates that Facebook® marketing resulted in 114,927 fans, 8,176 wall posts, 21,688 web site visits, and 117,476 total interactions. The sixth box 530 indicates that Twitter® marketing resulted in 502 active followers, 35,123 re-tweets, and 93,233 mentions. The seventh box 535 indicates that DoubleClick® display ads resulted in 5,140,100 impressions, with a 1.46% click through rate, 5,940 registrations, and 75,082 clicks. The eighth box 540 indicates that Google® display ads resulted in 20,033,380 impressions, with a 1.36% click through rate, 11,868 registrations, and 135,830 clicks. The ninth box 545 indicates that MS adCenter® display ads resulted in 1,951,285 impressions, with a 1.96% click through rate, 2,774 registrations, and 38,153 clicks.

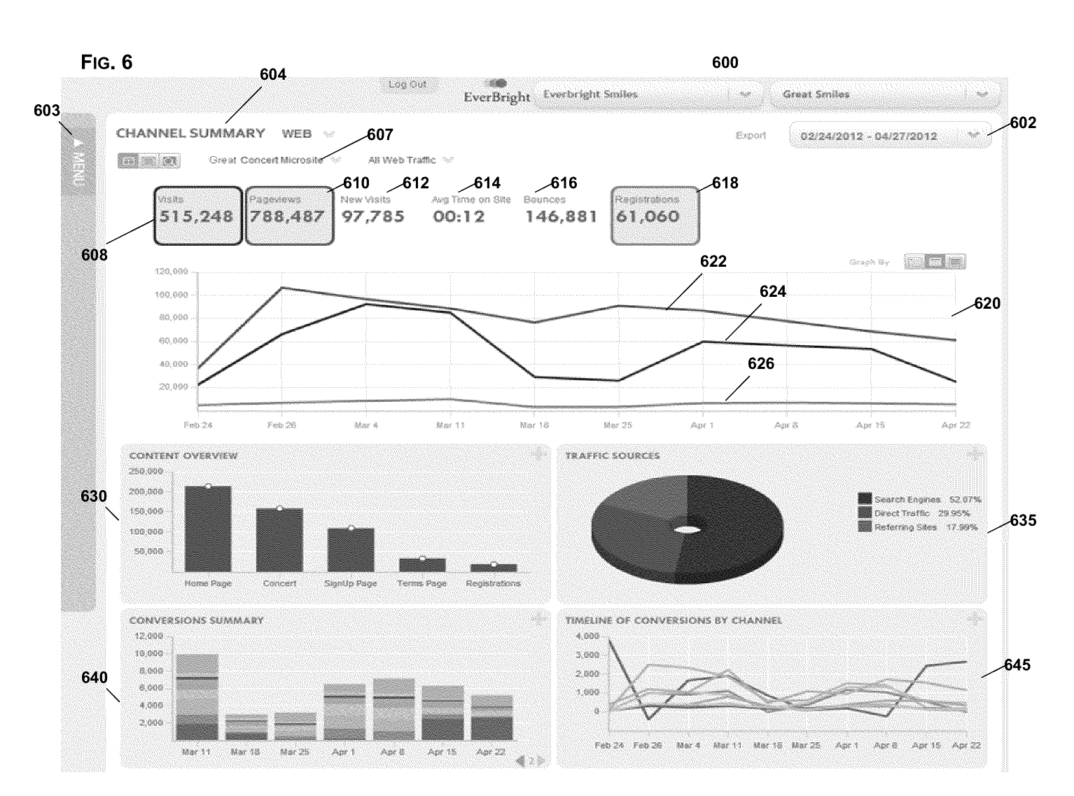

FIG. 6 is a screenshot of a channel summary display 600 depicting details of marketing channel impact on a web site, in accordance with one or more embodiments of the present disclosure. A date range 602 for the data is given near the upper right of the screenshot of FIG. 6. A flyout menu 603 appears at the left side of the screenshot of FIG. 6. A title 604, “Channel Summary[,] Web” starts near the top left of the screenshot of FIG. 6, the venue 607 of the web site (either a special web site or a particular page, in this case “Great Concert Microsite”) being shown below the title 604.

Continuing to refer to FIG. 6, several web usage metrics including number of web site visits 608, number of pageviews 610, number of new visits 612, average time on site per visit 614, number of bounces 616, number of registrations 618 are displayed below the title 604, and venue 607. Below the web usage metrics is a graph 620 depicting selected metrics over time. The three curves 622, 624, and 626 indicate selected metrics, in this case the number of pageviews 622, the number of web site visits 624, and the number of registrations 626. A content overview bar graph 630 depicts the number of web site visits for each of the home page, a concert web site page, a signup page, a terms page and a registration page. A traffic sources pie chart 635 indicates that 52.07% of the traffic to the web site comes from search engines, 29.95% comes from direct traffic, and 17.99% comes from referring sites. A conversions summary bar chart 640 is preferably color coded by marketing channel and displays conversions over time, on specific dates, by marketing channel. A conversion graph 645 is also color coded by channel and displays conversions over time by marketing channel.

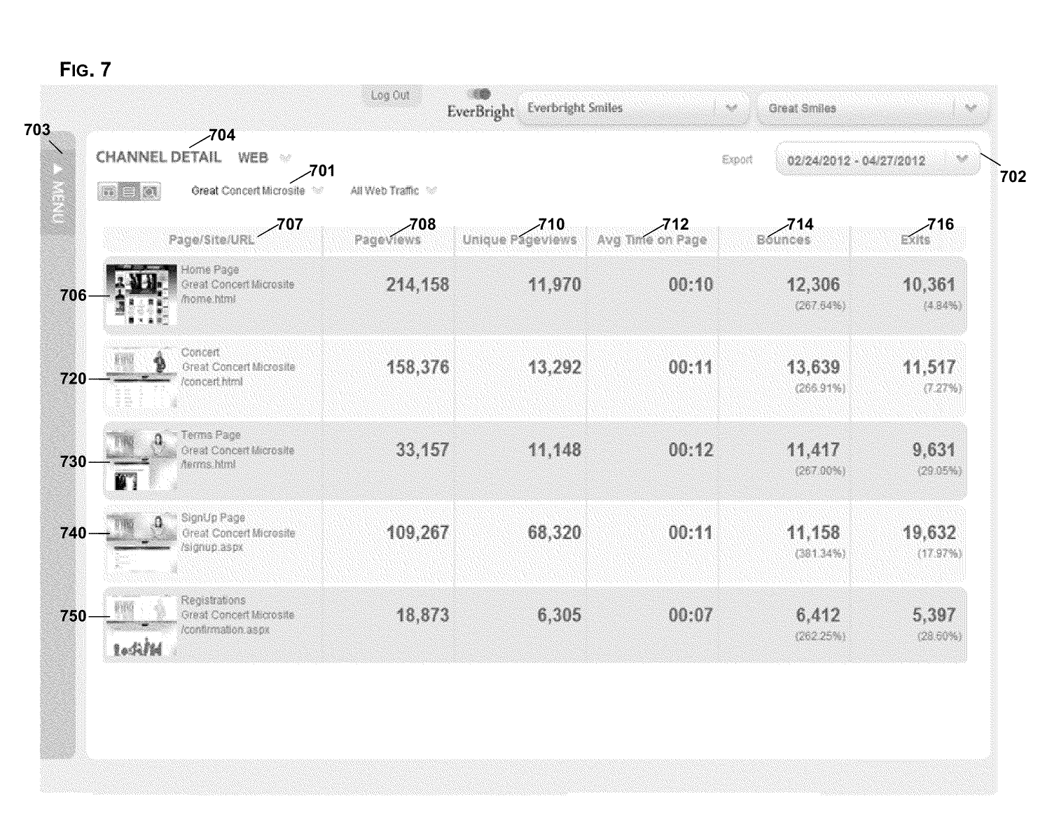

FIG. 7 is a screenshot of a summary display 700 depicting details of marketing channel results impacting various pages of a web site, in accordance with one or more embodiments of the present disclosure. In FIG. 7, the impact is broken down by page/site/URL, in accordance with one or more embodiments of the present disclosure. A date range 702 for the data is given near the upper right of the screenshot of FIG. 7. A flyout menu 703 appears at the left side of the screenshot of FIG. 7. A title 704, “Channel Detail[,] Web” starts near the top left of the screenshot of FIG. 7, the venue 701 of the web site (either a special web site or a particular page, in this case Great Concert Microsite) being shown below the title 704. In the example of FIG. 7, there are five rows 706, 720, 730, 740, 750 representing specific pages of the web site. In addition to the first column 707 listing the pages of the web site, there are five columns (a second column through a sixth column) 708, 710, 712, 714, 716 with information about different marketing channel impacts on each page of the web site listed. The second column 708 lists the number of pageviews for each of the five web site pages. The third column 710 lists the number of unique pageviews for each of the five web site pages. The fourth column 712 lists the average time on the page for each of the five web site pages. The fifth column 714 lists the number of bounces for each of the five web site pages. The sixth column 716 lists the number of exits for each of the five web site pages.

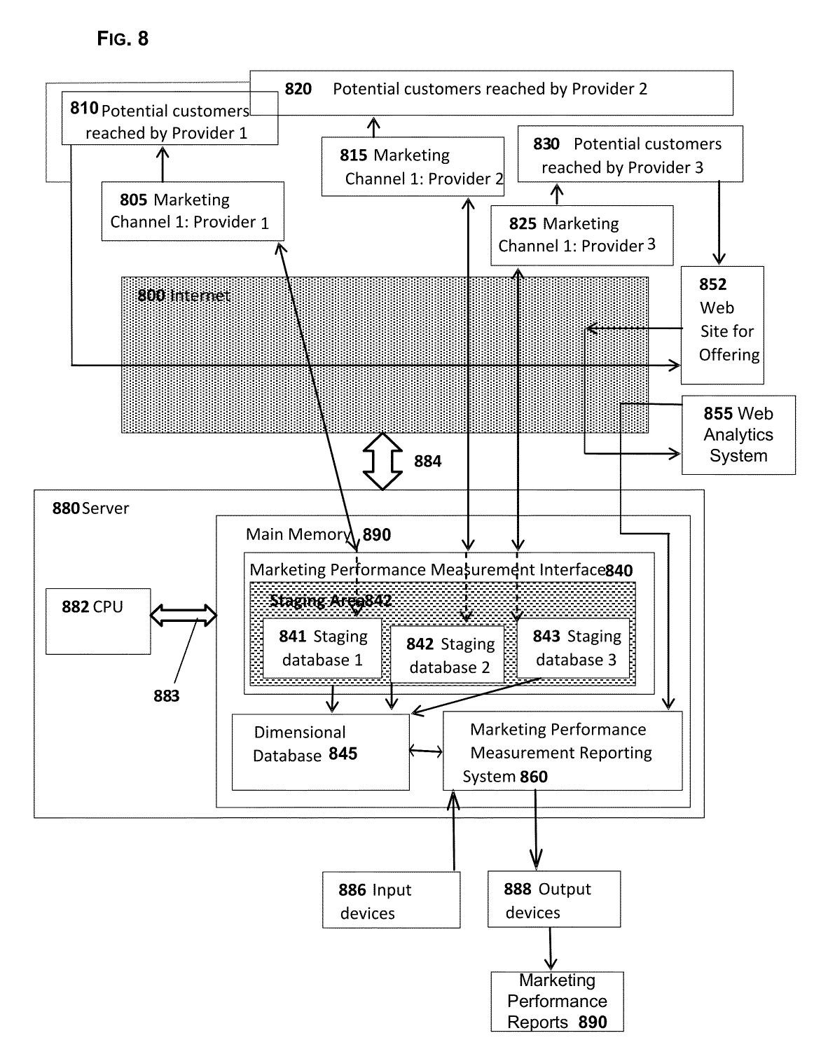

FIG. 8 is a block diagram depicting a system for analyzing and comparing marketing channels (in this example, the performance of two marketing channels and three providers), in accordance with one or more embodiments of the present disclosure. In the example of FIG. 8, none of the marketing channels are broadcast marketing channels. A provider 1 805 of a marketing channel 1, displays advertisements/marketing/conversations for an offering. Potential customers 810 reached by provider 1 805 may respond by going to (or clicking through to) a web site 852 for the offering, via the internet 800. (Some of the potential customers 810 reached by provider 1 805 may respond in different ways or not at all.) A provider 2 815 of the marketing channel 1 displays advertisements/marketing/conversations for the offering. Potential customers 820 reached by provider 2 815 may respond by going to (or clicking through to) the web site 852 for the offering, via the internet 800. (Some of the potential customers 810 reached by provider 2 815 may respond in different ways or not at all.) In some cases, the potential customers reached by one provider by overlap with the potential customers reached by another provider. In FIG. 8, the potential customers 820 reached by provider 2 815 have a degree of overlap with the potential customers 810 reached by provider 1 805. A provider 3 825 of marketing channel 2 displays advertisements/marketing/conversations for the offering. Potential customers 830 reached by provider 3 825 may respond by going to (or clicking through to) the web site 852 for the offering, via the internet 800. (Some of the potential customers 830 reached by provider 3 825 may respond in different ways or not at all.)

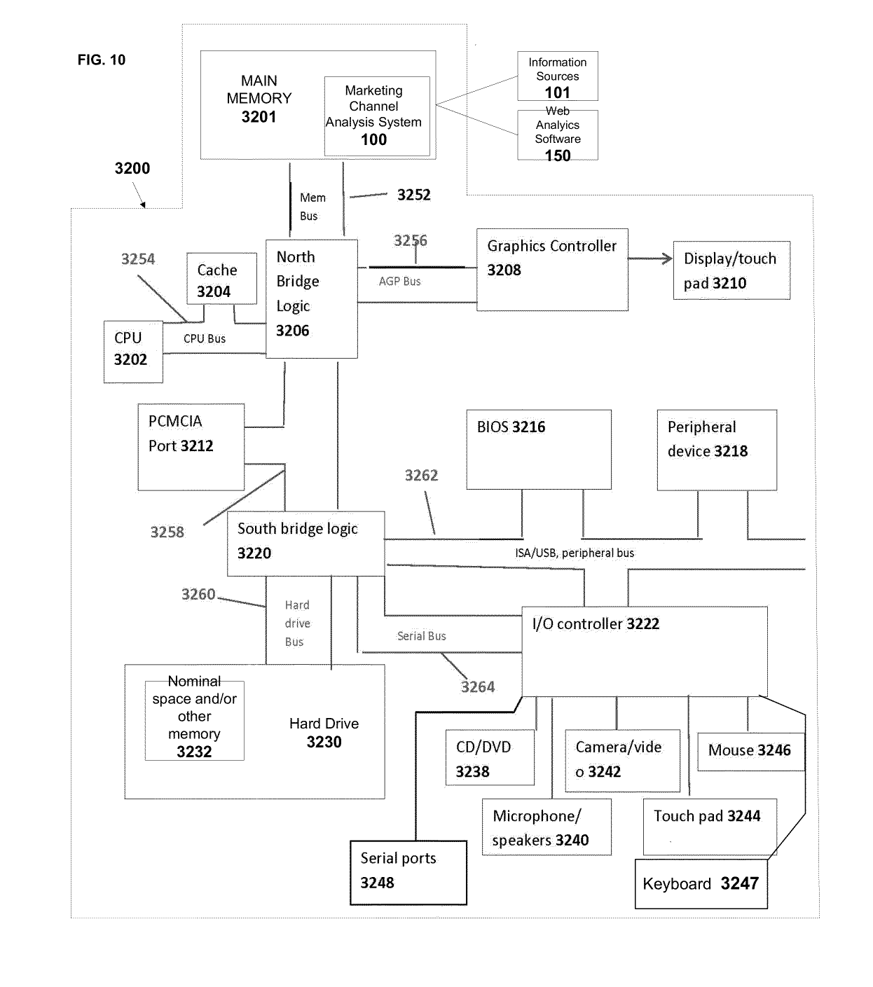

Continuing to refer to FIG. 8, a server 880 communicates over the internet 800 through an internet connection 884. (The server 800 of FIG. 8 is a simplified version; more detail of some components of a typical server in accordance with one or more embodiments of the present disclosure is provided in FIG. 10.) The internet connection 884 may be of any convenient kind, and may operate, for example, via hard wire or wirelessly. The server 880 has a central processing unit (“CPU”) 882 which may communicate through a bus 883 with a main memory 890. One or more input devices 886 and one or more output devices 888 allow user interaction with the server 880. Alternatively, the input devices 886 and/or the output devices 888 may be part of one or more client computer systems (not depicted in FIG. 8) in communication with the server 800.

Continuing to refer to FIG. 8, the main memory 890 includes a marketing performance measurement interface 840. The marketing performance measurement interface 840 communicates through the internet connection 884 and the internet 800 with the provider 1 805, the provider 2 815 and the provider 3 825, the marketing performance measurement interface 840 preferably continuously polling the provider 1 805, the provider 2 815, and the provider 3 825 for marketing performance data. The marketing performance measurement interface 840 includes a staging area 842, and has, in this example, a staging database for each provider, a staging database 1 841, a staging database 2 842, and a staging database 3 843. The provider 1 805, provider 2 815 and provider 3 825 provide their respective marketing performance data to the marketing performance measurement interface 840 in the form of compressed packets of data in a format specific to the sending provider. The marketing performance measurement interface 840 extracts the marketing performance data from the compressed packets and stores the marketing performance data in the appropriate staging database 1 841, 2 842, 3 843, depending on which provider provided the marketing performance data. The marketing performance measurement interface 840 transforms the uncompressed marketing performance data from the provider-specific formats to a specialized format of factual data and dimensional data, which is sent to a dimensional database 845.

Referring again to FIG. 8, a web analytics system 840 collects web usage information from the web site 852 and sends the web usage information to a marketing performance measurement reporting system 860. The marketing performance measurement reporting system 860 pulls the factual data and the dimensional data from the dimensional database 845. The marketing performance measurement reporting system 860 correlates the factual data and the dimensional data with the web usage information and uses the correlations to create one or more marketing performance reports 870, which may be displayed on (or printed by) one or more of the output devices 888. The marketing performance reports evaluate (compare and/or correlate) the performance of the two or more marketing channels, on the basis of one or more web usage metrics. The evaluations may include one or more other levels of granularity, such as an analysis of the marketing performance on a provider basis or a venue basis.

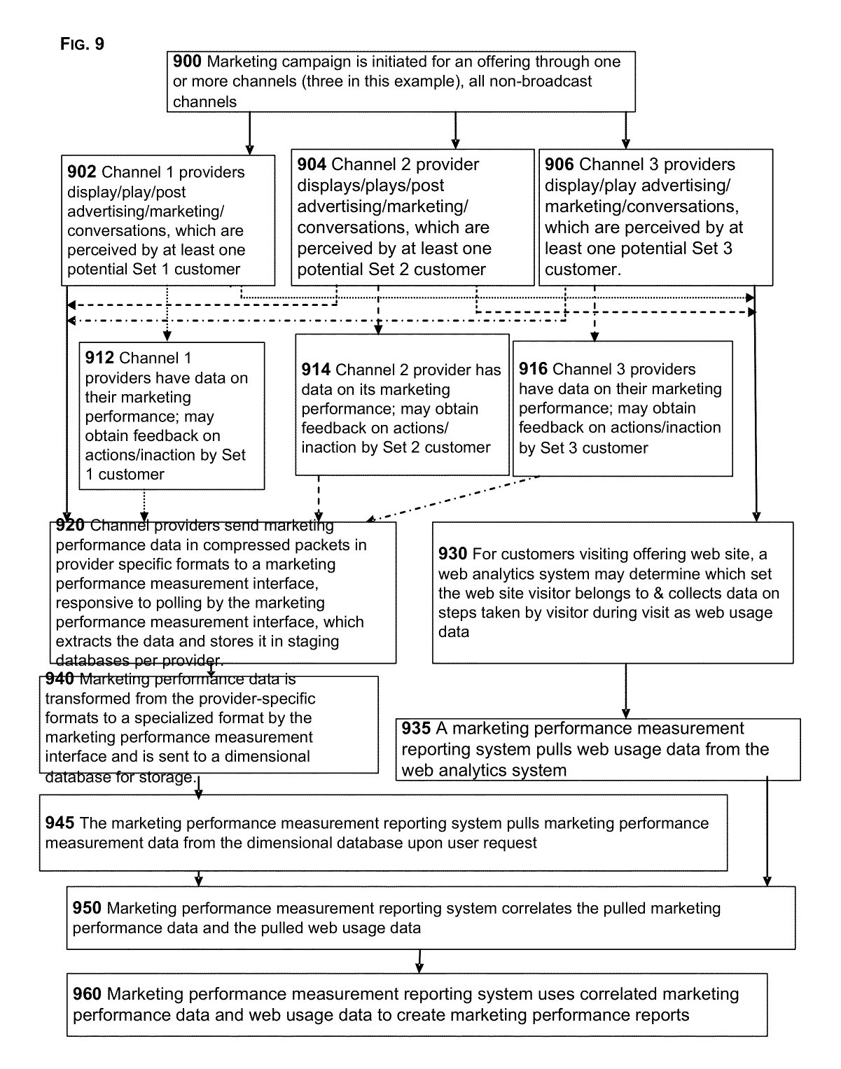

FIG. 9 is a flowchart depicting a process for analyzing and comparing the performance of marketing channels (in this example, the performance of three marketing channels), in accordance with one or more embodiments of the present disclosure. A marketing campaign is initiated for an offering through three channels. In the example of FIG. 9, in step 902, two or more providers of (marketing) Channel 1 display/play/post advertising/marketing/ conversations, which are perceived by at least one potential Set 1 customer. In step 904, a single provider of (marketing) Channel 2 displays/plays/posts advertising/marketing/conversations, which are perceived by at least one potential Set 2 customer. In step 906, two or more providers of (marketing) Channel 3 display/play advertising/marketing/conversations, which are perceived by at least one potential Set 3 customer.

In step 912, the providers of Channel 1 have data on their marketing performances and may obtain feedback on actions/inaction by Set 1 customers, the data and feedback comprising marketing performance data for the providers of Channel 1. In step 914, the provider of Channel 2 has data on its marketing performance and may obtain feedback on actions/inaction by Set 2 customers, the data and feedback comprising marketing performance data for the provider of Channel 2. In step 916, the Channel 3 providers have data on their marketing performances and may obtain feedback on actions/inaction by Set 3 customers, the data and feedback comprising marketing performance data for the providers of Channel 3.

Continuing to refer to FIG. 9, in step 920, the Channel providers send their respective marketing performance data in compressed packets in provider specific formats to a marketing performance measurement interface, responsive to polling by the marketing performance measurement interface. The marketing performance measurement interface extracts the data in the compressed packets and stores it in staging databases, one for each provider. In step 940, the marketing performance measurement interface converts the marketing performance data from the provider-specific formats to a specialized format of factual data and dimensional data and sends the marketing performance data in the specialized format to be stored in a dimensional database. For customers visiting an offering web site, in step 930, a web analytics system may determine which customer set the web site visitor belongs to and collects data on steps taken by visitor during visit, the determinations and the step data comprising web usage data. In step 935, the marketing performance measurement reporting system pulls the web usage data from the web analytics system. In step 945, the marketing performance measurement reporting system pulls the marketing performance measurement data in the form of factual data and dimensional data from the dimensional database upon user request. In step 950, the marketing performance measurement reporting system correlates the marketing performance data and the web usage data. In step 960, the marketing performance measurement reporting system uses the correlated marketing performance data and web usage data to create one or more marketing performance reports. The marketing performance reports evaluate, compare, and/or correlate (“evaluate” or “evaluations”) the performance of the two or more marketing channels, on the basis of one or more web usage metrics. The evaluations may include one or more other levels of granularity, such as an analysis of the marketing performance on a provider basis, a venue basis or an overall basis.

Turning now to FIG. 10, a depicted architecture includes a machine 3200 with a main memory 3201 storing a marketing channel analysis system 100, in accordance with one or more embodiments of the present disclosure. The machine 3200 may be configured in any number of ways, including as a laptop unit, a desktop unit, a network server, mobile device, telephone, net-book, or any other configuration. Machine 3200 generally includes a central processing unit (CPU) 3202 coupled to the main memory 3201 and to a variety of other peripheral computer system components through an integrated bridge logic device 3206. The bridge logic device 3206 is sometimes referred to as a “North bridge” for no other reason than it often is depicted at the upper end of a computer system drawing. The CPU 3202 couples to the North bridge logic 3206 via a CPU bus 3254, or the bridge logic 3206 may be integrated into the CPU 3202. The CPU 3202 may comprise, for example, of a i5 Core microprocessor. It should be understood, however, that the machine 3200 could include other alternative types of microprocessors. Further, an embodiment of the machine 3200 may include a multiple-CPU architecture, with each processor coupled to the bridge logic unit 3206. An external cache memory unit 3204 may further couple to the CPU bus 3254 or directly to the CPU 3202.

The main memory 3201 couples to the bridge logic unit 3206 through a memory bus 3252. The main memory 3201 functions as the working memory for the CPU 3202 and generally includes a conventional memory device or array of memory devices in which program instructions and data are stored. The main memory 3201 may comprise any suitable type of memory such as dynamic random access memory (DRAM), or any of the other various types of DRAM devices, such as synchronous DRAM (SDRAM), extended data output DRAM (EDO DRAM), or Rambus™ DRAM (RDRAM). The North bridge 3206 couples the CPU 3202 and main memory 3201 to the peripheral devices in the system through a Peripheral Component Interconnect (PCI) bus 3258 or other expansion bus, such as an Extended Industry Standard Architecture (EISA) bus. The present disclosure, however, is not limited to any particular type of expansion bus, and thus various buses may be used, including a high speed (66 MHz or faster) PCI bus. Various peripheral devices that implement the PCI protocol may reside on the PCI bus 3258 as well.

Referring again to FIG. 10, the marketing channel analysis system 100 stored in the main memory 3201 preferably includes components depicted in FIG. 1 and functions as in the description herein of that figure. One or more information sources 101 and a web analytics software 150 may be external to the machine 3200, but would be able to communicate with the marketing channel analysis system 100.

The machine 3200 includes a graphics controller 3208 that couples to the bridge logic 3206 via an expansion bus 3256. As shown in FIG. 10, the expansion bus 3256 comprises an Advanced Graphics Port (AGP) bus. Alternatively, the graphics controller 3208 may couple to bridge logic 3206 through the PCI bus 3258. The graphics controller 3208 may embody a typical graphics accelerator generally known in the art to render three-dimensional data structures on display 3210. Bridge logic 3206 includes a PCI interface to permit master cycles to be transmitted and received by bridge logic 3206. The bridge logic 3206 also includes an interface for initiating and receiving cycles to and from components on the AGP bus 3256. The display 3210 comprises any suitable electronic display device upon which an image or text can be represented. A suitable display device may include, for example, a cathode ray tube (CRT), a liquid crystal display (LCD), a thin film transistor (TFT), a virtual retinal display (VRD), a touch pad, or any other type of suitable display device.

The machine 3200 may comprise a computer system and may also optionally include a Personal Computer Memory Card International Association (PCMCIA) drive 3212 coupled to the PCI bus 3258. The PCMCIA drive 3212 is accessible from the outside of the machine and accepts one or more expansion cards that are housed in special PCMCIA cards, enclosures which are approximately the size of credit cards but slightly thicker. Accordingly, PCMCIA ports are particularly useful in laptop computer systems, in which space is at a premium. A PCMCIA card typically includes one connector that attaches to the PCMCIA port 3212, and additional connectors may be included for attaching cables or other devices to the card outside of the machine 3200. Accordingly, various types of PCMCIA cards are available, including modem cards, network interface cards, bus controller cards, and memory expansion cards. If other secondary expansion buses are provided in the computer system, another bridge logic device 3220 typically couples the PCI bus 3258 to that expansion bus. This bridge logic is sometimes referred to as a “South bridge,” reflecting its location vis-a-vis the North bridge in a typical computer system drawing.

In FIG. 10, the South bridge 3220 couples the PCI bus 3258 to an Industry Standard Architecture (ISA) bus 3262 and to a hard drive bus 3260. The hard drive bus 3260 typically interfaces input and output devices such as a CD ROM drive and/or Digital Video Disc (DVD) drive 3258, a hard disk drive 3230, microphone and/or speaker divers 3240, camera and/or video drivers 3242, a touch pad driver 3244, and/or a mouse driver 3246 in accordance with the embodiment of the disclosure shown in FIG. 10. The hard drive bus 3260 shown in FIG. 10 couples to the hard drive 3230, which has nominal space 3232 and may have other memory.

Also in FIG. 10, various ISA-compatible devices are depicted as coupled to the ISA bus 3262, including a BIOS ROM 3216. The BIOS ROM 3216 typically is a “nonvolatile” memory device, which means that the memory contents remain intact even when the machine 3200 powers down. By contrast, the contents of the main memory 3201 typically are “volatile” and thus are lost when the computer shuts down.

The South bridge 3220 of FIG. 10 supports an input/output controller 3222 that operatively couples to basic input/output devices such as a keyboard 3247, a mouse 3246, a CD/DVD drive 3258, general purpose parallel and serial ports 3248, and various input switches such as a power switch and a sleep switch (not shown). The I/O controller 3222 typically couples to the South bridge via a standard bus, shown as the ISA bus 3262 in FIG. 10. A serial bus 3264 may provide an additional connection between the I/O controller 3222 and South bridge 3220. The I/O controller 3222 typically includes an ISA bus interface (not specifically shown) to transmit and receive registers (not specifically shown) for exchanging data with the South bridge 3220 over the serial bus 3264.

In light of the principles and example embodiments described and illustrated herein, it will be recognized that the example embodiments can be modified in arrangement and detail without departing from such principles. Also, the foregoing discussion has focused on particular embodiments, but other configurations are contemplated. In particular, even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments that are combinable into other embodiments.

Similarly, although example processes have been described with regard to particular operations performed in a particular sequence, numerous modifications could be applied to those processes to derive numerous alternative embodiments of the present invention. For example, alternative embodiments may include processes that use fewer than all of the disclosed operations, processes that use additional operations, and processes in which the individual operations disclosed herein are combined, subdivided, rearranged, or otherwise altered.

This disclosure also described various benefits and advantages that may be provided by various embodiments. One, some, all, or different benefits or advantages may be provided by different embodiments.

In view of the wide variety of useful permutations that may be readily derived from the example embodiments described herein, this detailed description is intended to be illustrative only, and should not be taken as limiting the scope of the invention. What is claimed as the invention, therefore, are all implementations that come within the scope of the following claims, and all equivalents to such implementations.

What is claimed is:

1. A method, comprising:
collecting, over a time period in near real time, non-broadcast marketing performance data regarding marketing communications of an offering through at least two providers, the providers being from at least one non-broadcast marketing venue in at least one non-broadcast marketing channel, the non-broadcast marketing performance data collected on a per provider basis in provider-specific formats;
storing the near real time, non-broadcast marketing performance data for each provider in a staging database in a provider-specific format;
transforming the near real time, non-broadcast marketing performance data of each provider from the provider-specific formats to a specialized format;
storing the near real time, non-broadcast marketing performance data in a dimensional database in the specialized format;
collecting, over the time period in near real time, web site usage data, including at least one web usage metric, about an impact of the marketing communications, on at least a marketing campaign level of granularity, on a web site relating to the offering;
correlating the near real time, non-broadcast marketing performance data in the specialized format with the near real time, web site usage data to create at least one evaluation of the impacts of the marketing communications on at least one web usage metric and on at least an overall marketing level of granularity; and
creating a marketing performance report including the evaluation.

2. The method of claim 1, further comprising using the correlations to determine the extent of use of the marketing channels.

3. The method of claim 1, wherein the step of collecting over the time period in near real time, non-broadcast marketing performance data, on a per provider basis, regarding the marketing communications comprises:
obtaining non-broadcast marketing performance data as a compressed data packet, on a per provider basis, from each provider in near real time; and
extracting the non-broadcast marketing performance data from the compressed data packet and creating an un-compressed packet of the non-broadcast marketing performance data.

4. The method of claim 1, wherein the specialized format comprises factual data and dimensional data.

5. The method of claim 4, wherein the factual data is stored at a lowest dimensional level of the dimensional database.

6. The method of claim 1, wherein the at least one web usage metric includes a number of web site visits generated, a number of pageviews generated, a number of unique pageviews generated, a number of conversions generated, or a cost per conversion generated.

7. The method of claim 1, wherein at least two channels of marketing are compared on the basis of at least one of the following metrics: the number of pageviews generated by each channel, the number of unique pageviews generated by each channel, the average time on page generated by each channel, the number of bounces generated by each channel, the number of exits generated by each channel, the number of conversions generated by each channel, or the cost per conversion for each channel.

8. The method of claim 1, wherein the at least one evaluation of the impact on at least one web usage metric is on a marketing channel level of granularity.

9. The method of claim 1, wherein the at least one evaluation of the impact on at least one web usage metric is on a marketing venue level of granularity.

10. The method of claim 1, wherein the at least one evaluation of the impact on at least one web usage metric is on a provider level of granularity.

11. The method of claim 1, wherein the at least one evaluation of the impact on at least one web usage metric includes the impact of at least one provider and the impact of at least one marketing channel.

12. The method of claim 1, wherein the evaluation is expressed graphically.

13. The method of claim 12, wherein the evaluation is expressed graphically in the form of two concentric circles, an inner circle and an outer circle, for each marketing channel, and wherein the size of the outer circles are uniform and the size of each inner circle is representative of the relative impact on the web usage metric of the marketing communications of the marketing channel.

14. An apparatus, comprising:
a marketing performance data interface configured to collect, over a time period in near real time, non-broadcast marketing performance data regarding marketing communications for an offering through at least two providers, from at least one marketing venue in at least one non-broadcast marketing channel, the non-broadcast marketing performance data collected on a per provider basis;
a staging area within the marketing performance data interface having a staging database for each provider configured to store the non-broadcast marketing performance data from the provider in a provider-specific format;
the marketing performance data interface further configured to transform the non-broadcast marketing performance data from the provider-specific formats to a specialized format;
a dimensional database coupled to the marketing performance data interface, the dimensional database configured to store the non-broadcast marketing performance data in the specialized format;
a marketing performance measurement reporting system coupled to the dimensional database and to a web analytics system, the web analytics system being configured to obtain web site usage data from a provider in the at least one non-broadcast marketing channel and from a web site for the offering, the web site usage data including at least one web usage metric reflecting an impact of the marketing communications on a web site relating to the offering, the marketing performance measurement reporting system further configured to pull the non-broadcast marketing performance data from the dimensional database, to pull the web site usage data from the web analytics system, to correlate the pulled non-broadcast marketing performance data with the pulled web usage data to create at least one evaluation of the impacts on the basis of at least one web usage metric, at least an overall marketing campaign level of granularity, and to prepare a report including the evaluation.

15. The apparatus of claim 14, wherein the at least one evaluation of the impacts on the basis of the at least one web usage metric includes a comparison of the impacts on a marketing channel level of granularity.

16. The apparatus of claim 14, wherein the at least one evaluation of the impact on the basis of the at least one web usage metric includes a comparison of the impacts on a marketing venue level of granularity.

17. The apparatus of claim 14, wherein the at least one evaluation of the impact on the basis of the at least one web usage metric includes a comparison of the impacts on a provider level of granularity.

18. The apparatus of claim 14, wherein the at least one evaluation of the impact on the basis of the at least one web usage metric includes an evaluation of the impact of the marketing communication of at least one provider and the impact of the marketing communication of at least one marketing channel.

19. The apparatus of claim 14, wherein the at least one web usage metric includes a key metric, the key metrics of the impacts being compared visually.

20. The apparatus of claim 19, wherein the key metric includes a number of registrations generated, a number of web site visits generated or a cost of conversion generated.

21. The apparatus of claim 14, further comprising a display configured to display the report.

22. The apparatus of claim 14, wherein the web usage metrics are chosen from a group consisting of a number of pageviews generated, a number of unique pageviews generated, an average time on page generated, a number of bounces generated, a number of exits generated, the number of conversions generated, and the cost per conversion.

23. The apparatus of claim 14, wherein the evaluation is expressed visually.

24. The apparatus of claim 23, wherein the evaluation is expressed visually in the form of two concentric circles, an inner circle and an outer circle, for each marketing channel, and wherein the size of the outer circles are uniform and the size of each inner circle is representative of the relative impact on the web usage metric of the marketing communications of the marketing channel.

25. An article of manufacture comprising a medium storing instructions that, if executed, enables a processor-based system to:
collect, over a time period in near real time, non-broadcast marketing performance data regarding advertisements of an offering through two or more providers over the time period, the non-broadcast marketing performance data collected on a per provider basis;
store the near real time, non-broadcast marketing performance data the providers in at least one staging database in provider-specific formats;
transform the near real time, non-broadcast marketing performance data from the provider specific formats to a specialized format and store the re-formatted near real time, non-broadcast marketing performance data in a dimensional database;
collect, in near real time, web site usage data about the impact of the advertising on a web site relating to the offering, wherein the web site usage data is collected on a provider basis;
correlate the near real time marketing performance data with the near real time web site usage data, wherein the correlation includes a graphical comparison of the impacts of the at least two providers in a web usage metric; and
display the correlation.

26. The article of claim 25, wherein the graphical comparison of the impacts of the advertising of at least two providers in the web usage metric takes the form of two concentric circles, an inner circle and an outer circle, for each provider, wherein the size of the outer circles are uniform and the size of each inner circle is representative of the relative impact on the web usage metric for that provider.

27. A system, comprising:
at least two provider computer systems of at least two providers configured to assemble non-broadcast marketing performance data regarding marketing communications for an offering, the non-broadcast marketing performance data being assembled in a provider-specific format, and the at least two providers being from at least one marketing venue in at least one non-broadcast marketing channel;
a marketing performance data interface coupled to the at least two provider computer systems configured to collect, over a time period in near real time, the non-broadcast marketing performance data from the at least two computer systems, over the time period, the non-broadcast marketing performance data collected on a per provider basis;
a staging area within the marketing performance data interface having a staging database for each provider configured to store the non-broadcast marketing performance data from the provider in the provider's provider-specific format;
the marketing performance data interface further configured to transform the non-broadcast marketing performance data from the provider-specific formats to a specialized format;
a dimensional database coupled to the marketing performance data interface, the dimensional database configured to store the non-broadcast marketing performance data in the specialized format;
a web site for the offering accessible to potential customers;
a web analytics system configured to obtain web site usage data from a provider in the at least one non-broadcast marketing channel and from the web site for the offering, the web site usage data including at least one web usage metric, about the impact of marketing communications, on at least an overall marketing campaign level of granularity, on the web site relating to the offering; and
a marketing performance measurement reporting system configured to pull the non-broadcast marketing performance data from the dimensional database, to pull the web site usage data from the web analytics system, to correlate the pulled non-broadcast marketing performance data with the pulled web usage data to create at least one evaluation of the impacts on the basis of at least one web usage metric, at least an overall marketing level of granularity, and to prepare a report including the evaluation.
